(19) United States
(12) Patent Application Publication
(10) Pub. No.: US 2022/0101140 A1
(43) Pub. Date: Mar. 31, 2022

(54) UNDERSTANDING DEEP LEARNING MODELS

(71) Applicant: Telefonaktiebolaget LM Ericsson (publ), Stockholm (SE)

(72) Inventors: Perepu SATHEESH KUMAR, Chennai (IN); SARAVANAN M, Chennai (IN)

(73) Assignee: Telefonaktiebolaget LM Ericsson (publ), Stockholm (SE)

(21) Appl. No.: 17/618,678

(22) PCT Filed: Jun. 14, 2019
(86) PCT No.: PCT/IN2019/050455

§ 371 Date: Dec. 13, 2021

(51) Int. Cl. G06N 3/08

(52) U.S. Cl. CPC G06N 3/08

(57) ABSTRACT

A method for explaining deep-learning models is provided. The method includes extracting a set of features from a first deep-learning model for a first set of training data; clustering the set of features into N groups, wherein N represents a number of unique labels in the first set of training data; forming a clustering matrix from the N groups; and determining dominant columns in the clustering matrix to form a subset of the set of features.

### TECHNICAL FIELD

Disclosed are embodiments related to understanding deep learning models, and in particular, improving the explainability and/or interpretability of such deep learning models.

### BACKGROUND

The vision of the Internet of Things (IoT) is to transform traditional objects to being smart objects by exploiting a wide range of advanced technologies, from embedded devices and communication technologies to Internet protocols, data analytics, and so forth. The potential economic impact of IoT is expected to bring many business opportunities and to accelerate the economic growth of IoT-based services. Based on a McKinsey's report for the economic impact of IoT by 2025, the annual economic impact of IoT is expected to be in the range of $2.7 trillion to $6.2 trillion. Healthcare constitutes the major part (about 41% of this market), followed by industry and energy (about 33%) and the IoT market (about 7%).

The communication industry plays a crucial role in the development of other industries, with respect to IoT. For example, other domains such as transportation, agriculture, urban infrastructure, security, and retail have about 15% of the IoT market. These expectations imply the tremendous and steep growth of IoT services, their generating big data, and consequently their related market in the years ahead. The main element of most of these applications is an intelligent learning mechanism for prediction (including classification and regression), or for clustering. Among the many machine learning approaches, “deep learning” has been actively utilized in many IoT applications in recent years.

These two technologies (deep learning and IoT) are among the top three strategic technology trends for next few more years. The ultimate success of IoT depends on the execution of machine learning (and in particular deep learning) in that IoT applications which will depend on accurate and relevant predictions, which can for example lead to improved decision making.

Recently, artificial intelligence and machine learning (which is a subset of artificial intelligence) have enjoyed tremendous success with widespread IoT applications across different fields. Currently, applications of deep learning methods have garnered significant interest in different industries such as healthcare, telecommunications, e-commerce, and so on. Over the last few years, deep learning models inspired by the connectionist structure of the human brain, which learn representations of data at different levels of abstraction, have been shown to outperform traditional machine learning methods across various predictive modeling tasks. This has largely been attributed to their superior ability to discern features automatically via different representations of data, and their ability to conform to non-linearity, which is very common in real world data. Yet these models (i.e. deep learning models) have a major drawback in that they are among the least interpretable and understandable of machine learning models. The method by which these models arrive at their decisions via their weights is still very abstract.

For instance, in the case of Convolutional Neural Networks (CNNs), which are a subclass of deep learning models, when an image in the form of a pixel array is passed through the layers of a CNN model, the lower level layers of the model discern what appears to be the edges or the basic discriminative features of the image. As one goes deeper into the CNN model's layers, the features extracted are more abstract and the model's working is less clear and less understandable to humans.

This lack of interpretability has fostered some reservations regarding machine learning models, despite their successes. Regardless of their successes, it is paramount that such models are trustworthy for them to be adopted at scale. This lack of interpretability could hinder the adoption of such models in certain applications like medicine, telecommunication, and so on, where it is paramount to understand the decision-making process as the stakes are much higher. For an instance, a doctor is less likely to trust the decisions of a model if he is not clear about its approach, especially, if it were to conflict with his own decision. However, the problem with typical machine learning models is that they function as black-box models without offering explainable insights into their decision making process.

Prior work has dealt with interpretability in machine learning. Building models that are easily explainable are key to the advancement of the field. Traditionally, rule-based learners and decision trees have been easily interpretable by humans. However, owing to their drawbacks in terms of accuracy and robustness, newer approaches to machine learning, which are harder to interpret, have been developed. Deep neural networks fall into this category. Some work has made use of bag-nets to approximate CNNs. Such work has revealed CNNs leveraging texture rather than edge features to arrive at their decisions. Other techniques to tackle the issue of interpretability include: monitoring the outputs and perturbing the inputs; providing textual explanation based on visual queues and leveraging technique of image captioning and adapting different architectures; and explainable neural architectures specifically catered to be interpretable. Other work has demonstrated a model-agnostic method to offer visual explanations for decisions. The work involves perturbing the input image to understand how changes to the local neighborhood of a portion of the image affect the output. This method, while effective for providing visual cues affecting the models decision, only works on the inputs and outputs. It does not provide insight with regard to a model's internal working, such as the filters and layers that were crucial to the model's outcome. Further, the method relies on the saliency of super pixels which could be unreliable. Other work also depends on masking the input image randomly and offering post-hoc explanations in the form of importance maps.

### SUMMARY

Available methods for explainability have limitations in that, they require significant human effort along with high computational costs. Prior work also cannot clearly address the internal components of the model responsible for the model's decision. While prior work has tested the learning of the model at different levels of abstractions, they do not solve the issue of interpretability completely. They are focused on explaining features that are induced by human understanding, and some such methods apply only to a particular type of architecture, and therefore do not apply to all models.

Embodiments provided herein tackle the issue of interpretability specifically in deep learning applications. Considering the drawbacks of previous work, embodiments provide a novel alteration mechanism in the execution of deep learning methods for different applications. Embodiments are applicable to any architecture, in addition to the implementation of different modeling techniques.

Examples are provided herein to demonstrate the novel modeling techniques. Specifically, two examples are provided: (1) alarm prediction in telecommunication networks and (2) diabetes prediction in a healthcare environment. Alarm prediction can be a very complex problem to understand the relevant features which contribute to real alarm prediction by avoiding too many false alarm signals. Likewise, with respect to healthcare, understanding the contributable features and their relevancy through disclosed embodiments can clear the doubts of doctors and other healthcare providers, allowing them to take immediate decisions based on the model outcomes.

Embodiments provide for explainable classification and/or regression. Embodiments do so, for example, by using clustering techniques. By clustering the layer neuron outputs of some models, for instance, dominant features may be identified, as well as filters which can be used as a proxy for classification or regression.

Embodiments provide for: (1) an explainable clustering approach, e.g. to classify images (or other data) based on features extracted by a deep neural network; (2) an approach to understand appropriate features that may affect the decision making of the neural network; and (3) an approach to use the learned features to improve the classification accuracy. Doing this may augment the performance of the learning model and establish the trustworthiness of the model outcomes to those working in in mission-critical applications that may rely on the models to make decisions. Advantages of the embodiments include developing trust of an end user of deep learning models for effective use in mission-critical applications and improved understanding of the inner workings of the model (e.g. of the filters and locations of input data) to provide for improved trust. Embodiments are also computationally efficient and can be run with limited computational resources, e.g. with processors such as a Rasberry Pi computer.

According to a first aspect, a method for explaining deep-learning models is provided. The method includes extracting a set of features from a first deep-learning model for a first set of training data; clustering the set of features into N groups, wherein N represents a number of unique labels in the first set of training data; forming a clustering matrix from the N groups; and determining dominant columns in the clustering matrix to form a subset of the set of features.

In some embodiments, the method further includes modifying the first deep-learning model to form a second deep-learning model. Modifying the first deep-learning model to form the second deep-learning model comprises: for each feature in the subset of the set of features, determining a corresponding filter in the first deep-learning model and a corresponding feature location, wherein each of the corresponding filters forms a subset of filters; and training the second deep-learning model based on the corresponding filter and feature location of each feature in the subset of the set of features. The second deep-learning model comprises the subset of filters.

In some embodiments, determining dominant columns in the clustering matrix comprises: modifying a column in the clustering matrix; determining a change in accuracy of the first deep-learning model based on the modified column; and determining whether the column is dominant based on whether the change in accuracy exceeds a threshold. In some embodiments, determining dominant columns in the clustering matrix further comprises: modifying a further column in the clustering matrix; determining a further change in accuracy of the first deep-learning model based on the modified further column; determining whether the further column is dominant based on whether the further change in accuracy exceeds the threshold; and repeating these steps until each of the columns in the clustering matrix has been modified and determined to be dominant or not dominant. In some embodiments, the threshold is a percentage value.

In some embodiments, the first deep-learning model comprises a Convolutional Neural Network (CNN) having at least a convolutional block and a pooling block, and wherein extracting the set of features comprises taking the outputs of one or more of the convolutional block and the pooling block. In some embodiments, clustering the set of features into N groups comprises performing a k-means clustering algorithm. In some embodiments, the first deep-learning model comprises one or more of a classification model and a regression model.

According to a second aspect, a node adapted for configuring devices for a user is provided. The node includes a data storage system; and a data processing apparatus comprising a processor, wherein the data processing apparatus is coupled to the data storage system. The data processing apparatus is configured to: extract a set of features from a first deep-learning model for a first set of training data; cluster the set of features into N groups, wherein N represents a number of unique labels in the first set of training data; form a clustering matrix from the N groups; and determine dominant columns in the clustering matrix to form a subset of the set of features.

According to a third aspect, a node is provided. The node includes an extracting unit configured to extract a set of features from a first deep-learning model for a first set of training data; a clustering unit configured to cluster the set of features into N groups, wherein N represents a number of unique labels in the first set of training data; a forming unit configured to form a clustering matrix from the N groups; and a determining unit configured to determine dominant columns in the clustering matrix to form a subset of the set of features.

According to a fourth aspect, a computer program is provided. The computer program includes instructions which when executed by processing circuitry of a node causes the node to perform the method of any one of the embodiments of the first aspect.

According to a fifth aspect, a carrier is provided. The carrier contains the computer program of the fourth aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 shows a system according to an embodiment.

FIG. 2 shows a system according to an embodiment.

FIG. 3 shows a flow chart according to an embodiment.

FIG. 4 shows a sequence diagram according to an embodiment.

FIG. 5 shows a flow chart according to an embodiment

FIG. 6 shows a flow chart according to an embodiment.

FIG. 7 is a block diagram illustrating an apparatus, according to an embodiment, for performing steps disclosed herein.

FIG. 8 is a block diagram illustrating an apparatus, according to an embodiment, for performing steps disclosed herein.

### DETAILED DESCRIPTION

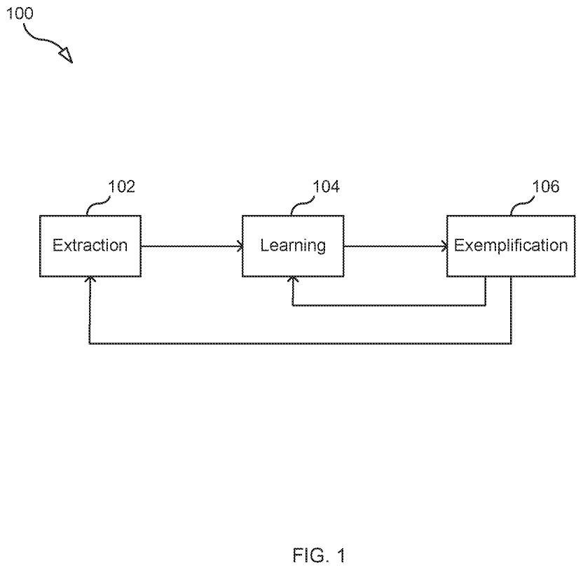

FIG. 1 illustrates a system according to an embodiment. As shown, system 100 includes an extraction block 102, a learning block 104, and an exemplification block 106. These blocks may be interconnected to each other in various ways, such as illustrated in FIG. 1.

Extracting block 102 may be configured to extract features from input data, such as training data. Learning block 104 may be configured to learn which features are important or significant for the model. Exemplification block 106 may be configured to use the learned features to improve classification. The functionality of these blocks will be described in greater detail in relation to disclosed embodiments.

Extracting block 102 is involved with building the classification model by extracting the relevant features.

A deep learning model includes a feature extractor. For discussion purposes, a Convolution Neural Network (CNN) model, which is a subcategory of the deep learning models, is considered here. Other types of deep learning models are also applicable to the disclosed embodiments. For example, feature extraction can be managed with other deep learning methods by taking all the hidden layer outputs. Focusing on CNNs, CNNs have had tremendous success in visual recognition tasks, achieving near human accuracy for many challenging tasks. The success of these models can be attributed to their superior ability to identify features. In addition, CNN models have also used to understand the features in both structured and unstructured data. CNNs may be designed to be invariant to a certain degree of shift, scale, and distortion via local receptive fields, weight sharing, and spatial sub sampling. As the layers are stacked in the CNN, each layer receives inputs from a set of units in a small neighborhood in the preceding layer. These repetitive local receptive fields facilitate the learning of features such as edges, points, and so forth, at different levels of abstraction.

Learning using local receptive fields may be facilitated by filters and convolutions. At each layer, filters are made to convolve upon the layer inputs. Each of these convolutions go on to produce activation maps which can be thought of as a representation of the features identified by each filter. These activation maps are stacked for each filter that performs the convolution operation. Thus, the depth of the activation maps is equal to the number of filters. This entire series of operations form the convolutional block. It is essentially a representation of the features learned at each layer. Next is the pooling layer block. There are many different types of pooling, such as max pooling, average pooling, and so on. As max pooling is one of the most commonly used layer in a CNN model, this disclosure will usually refer to max pooling when discussing the pooling layer. However, it should be understood that any type of pooling layer may be used in the disclosed embodiments, and reference to max pooling is not meant to disclose other types of pooling layers. The max pooling block works based on down-sampling the feature representations. It does so by applying a filter to non-overlapping sub-regions of the previous layer and projecting the max value from that region onto the next. This creates a more abstract representation of the features by only picking the dominant values. This helps reduce the number of parameters and allows to model to generalize better.

Both the convolutional and max pooling blocks constitute the feature extractor of the CNN model. In order to build a classifier (e.g. an image classifier), additional fully connected layers with suitable activation functions are stacked on top of the feature extractor. For purposes of this discussion, and in order to improve interpretability of the model, the feature extractor part of the model is focused on here. The max-pooled features at each level may be used, for example, to derive a generalized set of feature vectors describing the input data (e.g. text, images, or other values).

The choice of taking the max pooling layer leads to computationally efficiency. For example, assume a 2×2 max pooling layer in the model. In this case, with stride of 1, the amount of data is decreased by 75%, leaving 25% of the data after the max pooling layer. The result, based on the max pooling in the layer, is similar information about the dominant filters as in the convolution layer, but with much less computational complexity and little if any reduction in performance.

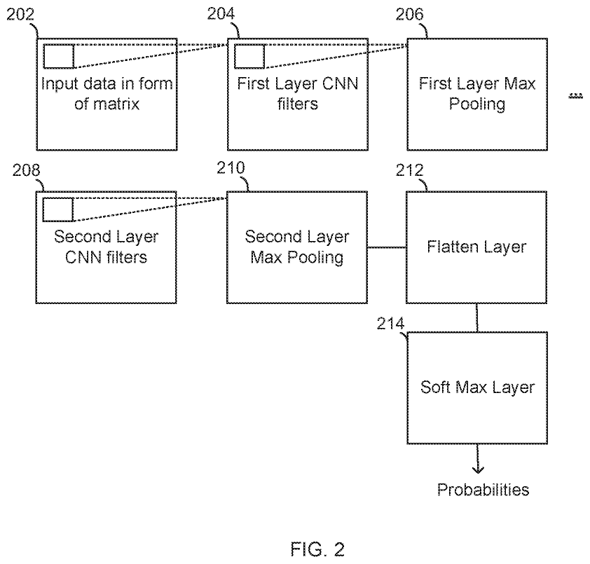

FIG. 2 illustrates a block diagram showing an exemplary convolutional and max pooling blocks of a CNN model comprising the feature extractor of the CNN model. As shown, input data 202 (in matrix form) may be passed to a first layer 204 of (e.g. convolutional) filters in the CNN model, which is then passed to a first max pooling layer 206. There may be additional layers that are not illustrated. For example, a second layer 208 of (e.g. convolutional) filters (whose input is based upon the output of the earlier layers), may be passed to a second max pooling layer 210, which is then passed to a flattening layer 212 and finally a soft max layer 214 which outputs probabilities.

Learning block 104 is involved with learning important features and location information of the features from input data.

In extraction block 102, the features from the input data are extracted. For example, if the input is an image, extraction block 102 extracts all the features from the image, such as edges and curves; if the input image is text, extraction block 102 extracts all the features from the text, such as semantic features. However, simply based on the extracted features, it is not clear which features have contributed, and how significantly the features have contributed, to how the model has classified the input data. To determine this, learning block 104 is employed.

For instance, continuing with the CNN model example, given a set of feature vectors that describe input data, analyzing the relevance of the feature vectors can be performed as follows. The outputs of the max pooling layer for all of the input data (e.g. as obtained from extraction block 102) may be collected and then flattened, i.e. the matrix output for a pooling layer is transformed into a vector. The following assumptions are made for discussion purposes: there are three 2×2 max pooling layers in the model; input data is of size 10×10, filters are of size 2×2; there is only a single convolutional filter at each level of the CNN model; and all filters and max pooling layers have non-overlapping stride. In the first max pooling layer output, the output is of size 5×5 and in the second the output is of size 3×3 and in the last max pooling layer the output is of size 2×2. These (i.e. each max pooling layer output) are flattened out and concatenated. The final generated vector will then be of size 38×1 (=5×5+3×3+2×2=25+9+4). For each single input data point, there will be a corresponding vector of this size. Once these vectors are obtained, learning block 104 clusters them to groups, e.g. by using a K-means clustering algorithm. The number of clusters may be selected to be equal to the number of unique labels in the data.

The K-means clustering algorithm performs well, but other clustering techniques may also be used. K-means is a distance-based clustering algorithm which involves projecting data points in space and grouping them based on some distance based metric. The typical distance metric chosen is the Euclidean distance, but other metrics are also applicable.

Clustering the feature vectors into N groups where N is number of unique labels in the dataset can help to provide additional information about the model. For example, if there are no clusters, each input needs to be analyzed to understand the feature in the input. This is computationally complex. Therefore, by grouping the feature vectors into clusters, the computational complexity can be reduced.

Clustering feature vectors may reinforce the importance and value of the features, however they are not directly interpretable, as such vectors remain obscure to humans. Thus there is a need to transform these vectors into another space, where they may be better understood. Clustering these vectors can allow humans to identify the distinguishable characteristics in condensed form, thereby giving some insight into the decision making process of the model.

For example, assuming that there are two unique labels in the dataset, the feature vectors will be divided into two clusters. To name these clusters, we can use the largest dominating label in the cluster as the cluster name. As an example, if there are 100 variables that are clustered, out of which the first cluster has 40 “dogs” and 10 “cats”, and the second cluster has 10 “dogs” and 40 “cats,” then we can name the first cluster as “dog” and the second as “cat.”

By looking at the output of all the data (e.g. images) in a single cluster, the output can be easily related to the labelled images, and a human observer can understand which feature is predominant and which feature is not. This may be done manually to ensure good optimality. However, in order to automate the process, additional processing is needed, as described below.

For example, as a result of clustering the feature vectors, a clustering matrix may be formed. A clustering matrix may comprise a set of feature vectors, such as each of the feature vectors of a given cluster. In any set of vectors that are being clustered, there may be some vectors (columns in the clustering matrix) that will be dominating and others that will not be dominating. For example, consider two matrices A and B as below:

$$A = [ \begin{matrix}2 & 3 & 4 \\ 1 & 3 & 2 \\ 2 & 3 & 1\end{matrix} ] ; B = [ \begin{matrix}2 & 10 & 4 \\ 1 & 12 & 2 \\ 2 & 10 & 1\end{matrix} ]$$

In the A matrix case, almost all of the columns are equally placed no one of them is dominating over the others. In the B matrix case, the second column looks dominating. Hence, in the B matrix case, the second column will influence the clustering more than the other columns.

In general, a CNN model may have several convolution layers, and each convolution layer may have many filters comprising the convolution layer. A given model may have a larger number of filters, for example, because it is unclear how each filter extracts the features. Experience with such models suggests that, out of all the filters for a given model, typically only about 10% of the filters will extract information. By looking at the outputs of those 10% of filter, one can see the important information on the input data. However, this is not easy in practice since no one knows which filter is dominating. Therefore, by focusing on determining dominant columns in cluster matrices, embodiments herein can identify filters which are performing better (or are more important, relative to the features and the input data) than others.

Consider the following procedure for learning the important features. First, construct a matrix with all max pooling layer outputs for each of the input data (this can be referred to as the “max pooling matrix” or alternatively the “clustering matrix”). For discussion purposes, assume the matrix is of size M×N, i.e. there are N elements coming from max pooling layer outputs, coming from M data points. Next, some of the columns of the matrix may be changed, e.g. by adding some amount of random data to the columns. If a particular column is dominant, then the clustering pattern should change following the change to the column; conversely, if the column is not dominant, then the clustering pattern should remain same following the change to the column. For instance, after changing a column, the clustering algorithm may be performed to determine whether the clustering pattern has changed or remained the same.

The columns in the max pooling matrix correspond to each filter output for one portion of entire data. For example, let us take the case of the previous example, where there are three 2×2 max pooling layers in the CNN architecture. In addition, assume that the input data is of size 10×10, the filters are of size 2×2, and that there is only a single convolutional filter at each level. In this case, the vectors will have a size of 38 elements, of which 25 elements belong to max pooling layer 1, 9 elements belong to max pooling layer 2, and the remaining 4 elements belong to max pooling layer 3. Continuing the example, it may be that out of the first 25 elements (corresponding to layer 1), the first element comes from filter 1 and from the first (1:2)×(1:2) portion of the input data, whereas the second element comes from filter 1 and the second (1:2)×(3:4) of the data. A similar interpretation may be given for the remaining elements. (Note that one filter may correspond to multiple features.) With this understanding, the way that columns are changed to determine dominant features may take, in some embodiments, the following approach. For instance, the corresponding filter columns in a particular layer may be changed, and the same thing may be repeated for every filter in each layer. In this way, the data in the matrix may be changed.

Now, upon changing the matrix, it becomes important to determine whether a particular change indicates if a particular column is dominant. For example, one procedure is to change the value by a small amount in a column corresponding to a particular filter and then to note the accuracy. If the columns are dominant, there should be a substantial change in accuracy (e.g. a decline or increase in accuracy). In embodiments, if the accuracy changes by a threshold amount (e.g. a percentage value, such as 40%), then the particular column that was modified can be considered dominant. The specific threshold used may depend on a number of factors, and an end-user may adjust it to suit particular needs. In embodiments, there may be a first threshold for detecting if an increase in accuracy determines a column as being dominant, and a second threshold for detecting if a decrease in accuracy determines a column as being dominant, where the first and second thresholds may be the same or may be different. This can be done (that is, changing a column and then noting a change in accuracy to determine if the column is dominant) for each of the columns in the clustering matrix, resulting in a list of columns that are dominant and another list of columns that are not dominant.

By looking at the dominant columns, it is possible to identify which filter is performing good and which filter is not. By knowing this information, it is further possible to improve the classification accuracy. This is explained in detail with respect to the exemplification block 106.

By looking at the dominant columns, it is possible to determine which filters are working better and which part of the input data contribute to those filters. This is valuable information, e.g. by looking at the particular feature at particular location, a user of the model may be able to gain trust for the model.

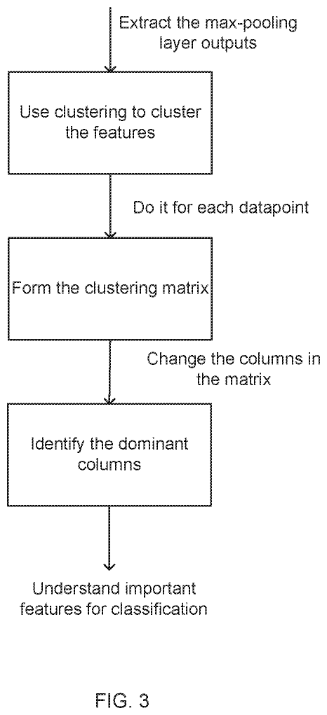

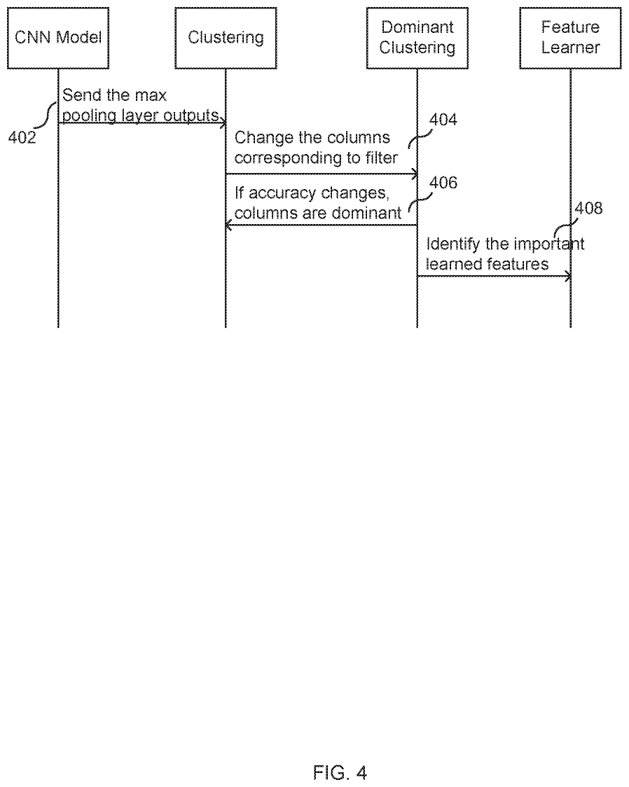

This dominance determining procedure, as just described, is illustrated by FIGS. 3 and 4. For example, FIG. 3 shows using clustering to cluster the features, which have been extracted from the max pooling layer outputs; forming the clustering matrix; and identifying the dominant columns by changing the columns and determining whether the change results in a change in accuracy that exceeds a threshold value. The identified dominant columns (corresponding to dominant features) may be used to better understand the model. Likewise, FIG. 4 shows the extraction of the max pooling layer outputs from the CNN model; clustering; and determining dominance by changing the columns and noting how much the accuracy changes in response. As a result, the important features are identified. Specifically, FIG. 4 shows that max pooling layer outputs can be sent 402 from the CNN model to a clustering unit. The clustering unit may then change 404 individual columns from a clustering matrix formed based on the pooling layer outputs. This may be performed in conjunction with a dominant clustering unit, which for example determines if a given column is dominant based on whether the accuracy changes 406 by a threshold amount. Based on this, the important (dominant) features are identified 408, in conjunction with a feature learner unit.

Exemplification block 106 is involved with using the understood and trusted features to improve the classification.

Given the important features discovered previously, and the location information regarding the location of the feature in the input data, this information can be used as the input to the model. Specifically, the model may be modified in the following manner: only the feature location (instead of the entire data) is used as input for the model, and only the dominating convolution filter in the convolution layer (instead of all the filters in the convolution layer) are used in the model. This modified model is trained by training only the filters corresponding to the dominant columns and only subset of input data corresponding to the location information regarding the location of the features in the input data. This modified model can then be used to predict the classification category of new data.

By knowing the dominating features and location in the input data of the dominating features, the classification accuracy may be improved.

For a data set, the following steps can be performed to evaluate the model. First, the data set is converted into matrix form. Second, the location of the data is extracted. Third, the trained CNN model (using only the dominant filters) is used to perform classification.

It should be noted that the accuracy obtained with the trained CNN model using only the dominant filters will typically be less than the accuracy of the original model. This is because the model is modified by removing the original filters which are not dominant from the original model. Although these filters are not dominant, they may contain some (potentially very low) information of the input data. Therefore, by removing those non-dominant filters, the information about the input data is lost and this can result in a decrease in the accuracy. However, the resulting model is more explainable and understandable to an end user, who gains trust in the model. There can therefore be a trade-off between accuracy and trust that occurs.

Two examples of the proposed method and system are now described. The first example relates to an alarm data set and the second example relates to a medical data set.

Alarms dataset: This is a dataset from a telecommunications service provider, involving alarms indicating an error in a node. The alarms may be either true (indicating an error in the node) or false (indicating no error in the node, but an alarm indication occurred anyway). The data collected covered four months. Three months of the data was used to train the model, with fourth month of data reserved for testing. Collected features included number of callers connected to the network (which is available for one-hour increments), number of call drops, number of available nodes, and so forth. The columns of data were normalized and considered in terms of percentages for purposes of training the model. The data was aggregated at hourly levels for purposes of this example. The example focused on 50 columns corresponding to the various key performance indicators (KPIs) of the network. The KPIs of the network are continuous variables and the alarm category (either true or false) is a categorical variable.

The data considered here was obtained from 19 locations across the world. There are 4 alarm types and 20 different node types in the data. The alarms have been labeled as true or false for every data point. The objective is to build a model which will predict whether a given alarm is true or false. The number of data points collected was 2,000; and out of the 2,000 data points, about 1,500 correspond to false alarms and 500 to true alarms.

First, features are extracted using the CNN model. This was discussed above with respect to extraction block 102. In this example, three convolution layers each followed by three max pooling layers were used in designing the CNN model. In each of the three convolution layers, there were 32 filters of size 5×5, with the three max pooling layers also of size 5×5. Further, the example model used a fully connected layer at the output to ensure a single value was obtained. Finally, a softmax function was used to convert the output to a probability.

To apply the CNN model of this example, the 50×1 input data is converted into an 8×8 matrix (using zero padding as necessary). Training of the model is stopped early so as to prevent overfitting of the model. Also, the percentage of dropouts is considered as 10%, and the model is trained for 18 epochs. It took about 10 minutes to build the model. The model's accuracy, for the testing data set, was about 92%.

Second, the important features are learned. This was discussed above with respect to learning block 104. As discussed, all the max pooling layer outputs are collected and flattened into a single vector, for each data point. These vectors are then collected for the entire data set and clustered into two clusters (for the two labels in this data set, “true” and “false”). In the first cluster, according to this example, there are 600 false alarms and 100 true alarms; and in second cluster, there are 100 false alarms and 200 true alarms. Accordingly, cluster 1 can be named the “false” cluster and cluster 2 can be named the “true” cluster. With this, the classification accuracy is decreased to 80%. This decrease in classification accuracy is due to interpretability of the model.

The next step is to identify the dominant columns in the clustering data to determine the dominant features. In this example, using a threshold of 40%, it turns out that the fifth and sixth columns are the dominant features. This corresponds to the first filter and the first 5×5 of the data (i.e. the first 25 columns of the data). As we go in depth into the inside filters, it is possible to locate the exact feature of the data. It should be noted that the dominance can be present in one or more features in the data. For example, in this example, a true alarm is obtained if (1) the call rate is decreased to less than 50% of a threshold and (2) the number of free frequencies is increased to 80% of a threshold. In this way, we can obtain the dominant features in the data.

Explicit rules may be generated from the data by identifying the dominant features and locations in the data. Using conventional deep learning models, it is difficult or impossible to obtain explicit rules where there are multiple features. Embodiments disclosed herein make it possible to obtain explicit rules even when there are multiple features, and therefore can help to develop good trust on the model for end users of the model.

Third, the model is improved using the learned features. This was discussed above with respect to exemplification block 106. Based on the dominant column analysis from above, the CNN model is modified by taking the first filter and the first 5×5 of the input data and using that data to train the model. In this case, the accuracy obtained is 85%. This demonstrates both an increase in accuracy with better segmentation of the data and also better understanding of the working filter of the CNN model.

For the case of alarm dataset, the proposed method took about 3 minutes and 880 MB. However, using a prior method for understanding machine learning models, the method (LIME) took about 30 minutes and 4 GB memory (with parallel processing using 4 cores). Thus, the present method is faster, requires less computational resources, and results in better understanding.

Medical (PIMA) dataset: This is a diabetics patient dataset called PIMA, which is available from https://www.kaggle.com/uciml/pima-indians-diabetes-database. The dataset has several features including age, weight, blood pressure, and so on. It has also labeled data, including whether the person has diabetes or not. Training and testing proceeded with this example in a similar manner as described above.

In this case, the accuracy obtained using a CNN model is 82%. After extracting features and learning the important features, the accuracy is decreased to 74%. After improving the model using the exemplification block, the accuracy increased to 78%.

In this example, the important feature that was learned is the weight of the patient. Specifically, if the weight of the patient is more than 80 KG, then the patient is most prune to being diabetic. By looking at this variable, a doctor can develop trust in the model (e.g. because weight is a known important factor to cause diabetes). In this way, an end user, such as a doctor, may develop trust with the model.

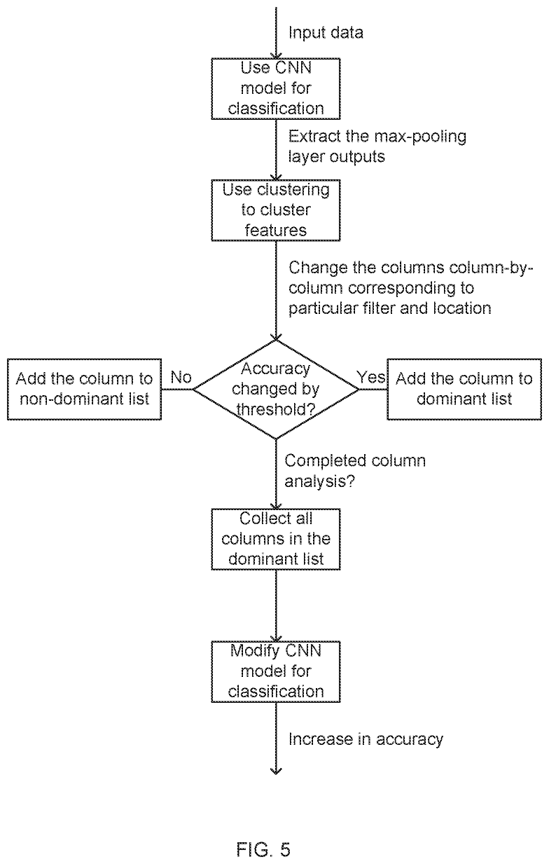

FIG. 5 illustrates a flow chart according to an embodiment. As shown, input data is fed into a CNN model for classification. The outputs of the max pooling layers of the CNN model are extracted, and taken as the features. The features are then clustered. Following this, a clustering matrix is formed, the columns (corresponding to features) of the matrix are determined to be dominant or not by changing the columns and observing whether the accuracy changes over a threshold amount. Once each of the columns have been determined to be dominant or not dominant, the dominant columns are collected, and the CNN model is modified to form a new model based on the dominant features and not the non-dominant features. This results in an improvement to accuracy.

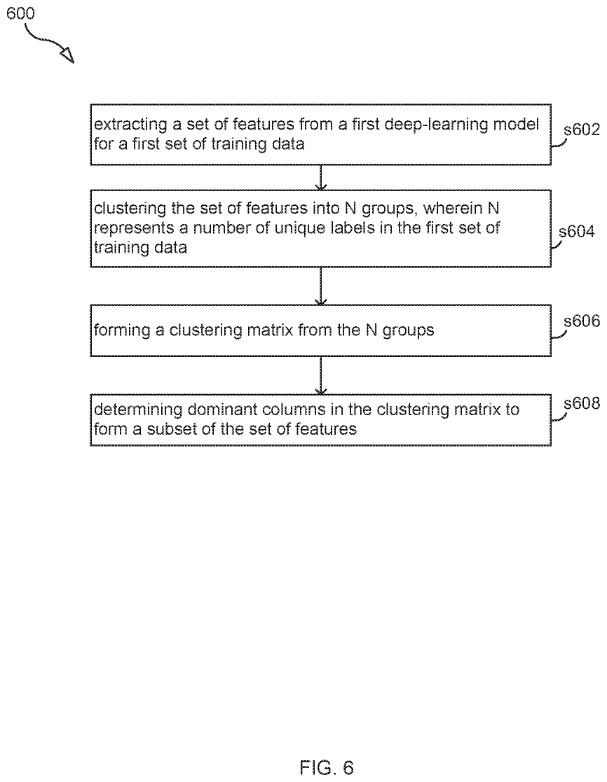

FIG. 6 is a flowchart illustrating a process 800 according to some embodiments.

Process 800 may begin with step s802.

Step s602 comprises extracting a set of features from a first deep-learning model for a first set of training data.

Step s604 comprises clustering the set of features into N groups, wherein N represents a number of unique labels in the first set of training data.

Step s606 comprises forming a clustering matrix from the N groups.

Step s608 comprises determining dominant columns in the clustering matrix to form a subset of the set of features.

In some embodiments, the method further includes modifying the first deep-learning model to form a second deep-learning model. Modifying the first deep-learning model to form the second deep-learning model includes: for each feature in the subset of the set of features, determining a corresponding filter in the first deep-learning model and a corresponding feature location, wherein each of the corresponding filters forms a subset of filters; and training the second deep-learning model based on the corresponding filter and feature location of each feature in the subset of the set of features. The second deep-learning model comprises the subset of filters.

In some embodiments, determining dominant columns in the clustering matrix comprises: modifying a column in the clustering matrix; determining a change in accuracy of the first deep-learning model based on the modified column; and determining whether the column is dominant based on whether the change in accuracy exceeds a threshold. In some embodiments, determining dominant columns in the clustering matrix further comprises: modifying a further column in the clustering matrix; determining a further change in accuracy of the first deep-learning model based on the modified further column; determining whether the further column is dominant based on whether the further change in accuracy exceeds the threshold; and repeating these steps until each of the columns in the clustering matrix has been modified and determined to be dominant or not dominant. In some embodiments, the threshold is a percentage value, such as 40%.

In some embodiments, the first deep-learning model comprises a Convolutional Neural Network (CNN) having at least a convolutional block and a pooling block, and wherein extracting the set of features comprises taking the outputs of one or more of the convolutional block and the pooling block. In some embodiments, clustering the set of features into N groups comprises performing a k-means clustering algorithm. In some embodiments, the first deep-learning model comprises one or more of a classification model and a regression model.

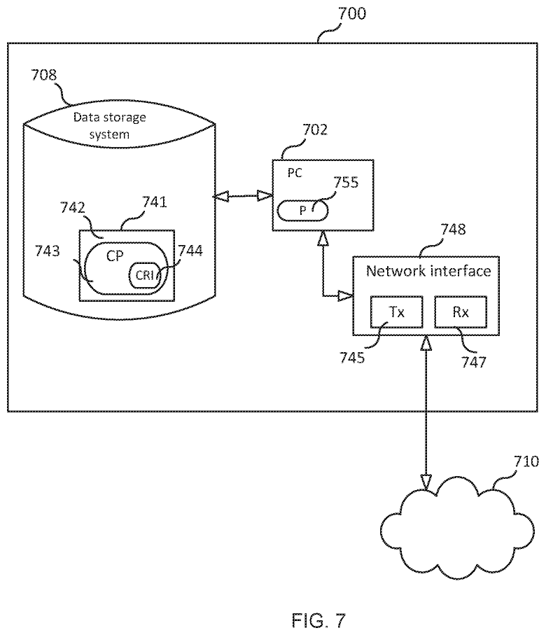

FIG. 7 is a block diagram of an apparatus 700, according to some embodiments. Apparatus 700 may be a network node, such as a base station, a computer, a server, or any other unit capable of implementing the embodiments disclosed herein. As shown in FIG. 7, apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors 755 may be co-located in a single housing or in a single data center or may be geographically distributed (i.e., apparatus 700 may be a distributed apparatus); a network interface 748 comprising a transmitter (Tx) 745 and a receiver (Rx) 747 for enabling apparatus 700 to transmit data to and receive data from other nodes connected to network 710 (e.g., an Internet Protocol (IP) network) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 943 is configured such that when executed by PC 702, the CRI causes apparatus 700 to perform steps described herein (e.g., steps described herein with reference to the flow charts). In other embodiments, apparatus 700 may be configured to perform steps described herein without the need for code. That is, for example, PC 702 may consist merely of one or more ASICs. Hence, the features of the embodiments described herein may be implemented in hardware and/or software.

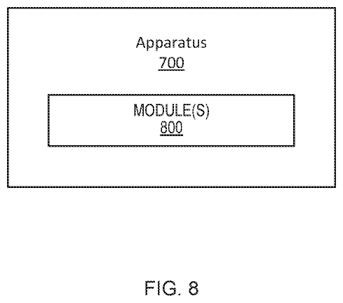

FIG. 8 is a schematic block diagram of the apparatus 700 according to some other embodiments. The apparatus 700 includes one or more modules 800, each of which is implemented in software. The module(s) 800 provide the functionality of apparatus 700 described herein and, in particular, the functionality of a network node (e.g., the steps herein, e.g., with respect to FIG. 6).

In some embodiments, the modules 800 may include an extracting unit configured to extract a set of features from a first deep-learning model for a first set of training data; a clustering unit configured to cluster the set of features into N groups, wherein N represents a number of unique labels in the first set of training data; a forming unit configured to form a clustering matrix from the N groups; and a determining unit configured to determine dominant columns in the clustering matrix to form a subset of the set of features.

While various embodiments are described herein (including the attached appendices which contain proposals to modify a 3GPP standard), it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for explaining deep-learning models, the method comprising:
extracting a set of features from a first deep-learning model for a first set of training data;
clustering the set of features into N groups, wherein N represents a number of unique labels in the first set of training data;
forming a clustering matrix from the N groups; and
determining dominant columns in the clustering matrix to form a subset of the set of features.

2. The method of claim 1, further comprising:
modifying the first deep-learning model to form a second deep-learning model,
wherein modifying the first deep-learning model to form the second deep-learning model comprises:
for each feature in the subset of the set of features, determining a corresponding filter in the first deep-learning model and a corresponding feature location, wherein each of the corresponding filters forms a subset of filters; and
training the second deep-learning model based on the corresponding filter and feature location of each feature in the subset of the set of features,
wherein the second deep-learning model comprises the subset of filters.

3. The method of any one of claim 1, wherein determining dominant columns in the clustering matrix comprises:
modifying a column in the clustering matrix;
determining a change in accuracy of the first deep-learning model based on the modified column; and
determining whether the column is dominant based on whether the change in accuracy exceeds a threshold.

4. The method of claim 3, wherein determining dominant columns in the clustering matrix further comprises:
modifying a further column in the clustering matrix;
determining a further change in accuracy of the first deep-learning model based on the modified further column;
determining whether the further column is dominant based on whether the further change in accuracy exceeds the threshold; and
repeating these steps until each of the columns in the clustering matrix has been modified and determined to be dominant or not dominant.

5. The method of claim 3, wherein the threshold is a percentage value.

6. The method of claim 1, wherein the first deep-learning model comprises a Convolutional Neural Network (CNN) having at least a convolutional block and a pooling block, and wherein extracting the set of features comprises taking the outputs of one or more of the convolutional block and the pooling block.

7. The method of claim 1, wherein clustering the set of features into N groups comprises performing a k-means clustering algorithm.

8. The method of claim 1, wherein the first deep-learning model comprises one or more of a classification model and a regression model.

9. A node adapted for explaining deep-learning models, the node comprising:
a data storage system; and
a data processing apparatus comprising a processor, wherein the data processing apparatus is coupled to the data storage system, and the data processing apparatus is configured to:
extract a set of features from a first deep-learning model for a first set of training data;
cluster the set of features into N groups, wherein N represents a number of unique labels in the first set of training data;
form a clustering matrix from the N groups; and
determine dominant columns in the clustering matrix to form a subset of the set of features.

10. The node of claim 9, wherein the data processing apparatus is further configured to:
modify the first deep-learning model to form a second deep-learning model,
wherein modifying the first deep-learning model to form the second deep-learning model comprises:
for each feature in the subset of the set of features, determining a corresponding filter in the first deep-learning model and a corresponding feature location, wherein each of the corresponding filters forms a subset of filters; and
training the second deep-learning model based on the corresponding filter and feature location of each feature in the subset of the set of features,
wherein the second deep-learning model comprises the subset of filters.

11. The node of claim 9, wherein determining dominant columns in the clustering matrix comprises:
modifying a column in the clustering matrix;
determining a change in accuracy of the first deep-learning model based on the modified column; and
determining whether the column is dominant based on whether the change in accuracy exceeds a threshold.

12. The node of claim 11, wherein determining dominant columns in the clustering matrix further comprises:
modifying a further column in the clustering matrix;
determining a further change in accuracy of the first deep-learning model based on the modified further column;
determining whether the further column is dominant based on whether the further change in accuracy exceeds the threshold; and
repeating these steps until each of the columns in the clustering matrix has been modified and determined to be dominant or not dominant.

13. The node of claim 11, wherein the threshold is a percentage value.

14. The node of claim 9, wherein the first deep-learning model comprises a Convolutional Neural Network (CNN) having at least a convolutional block and a pooling block, and wherein extracting the set of features comprises taking the outputs of one or more of the convolutional block and the pooling block.

15. The node of claim 1, wherein clustering the set of features into N groups comprises performing a k-means clustering algorithm.

16. The node of claim 9, wherein the first deep-learning model comprises one or more of a classification model and a regression model.

17. A node comprising:
an extracting unit configured to extract a set of features from a first deep-learning model for a first set of training data;
a clustering unit configured to cluster the set of features into N groups, wherein N represents a number of unique labels in the first set of training data;
a forming unit configured to form a clustering matrix from the N groups; and
a determining unit configured to determine dominant columns in the clustering matrix to form a subset of the set of features.

18. A computer program comprising instructions which when executed by processing circuitry of a node causes the node to perform the method of claim 1.

19. A carrier containing the computer program of claim 18, wherein the carrier is one of an electronic signal, an optical signal, a radio signal, and a computer readable storage medium.
